(19) United States
(12) Patent Application Publication
(10) Pub. No.: US 2026/0360119 A1
(43) Pub. Date: Nov. 12, 2026

(54) MACHINE LEARNING EXPLANATORY PIPELINE FOR FILTERING DATA FROM DISPARATE SOURCES

(71) Applicant: Optum, Inc., Minnetonka, MN (US)

(72) Inventors: Daniel W. James, Costa Mesa, CA (US); Rahul Bhaskar, Irvine, CA (US); Thomas Patrick Bellumori, Los Alamitos, CA (US); Sowmya Ram, Middletown, DE (US)

(21) Appl. No.: 19/205,354

(22) Filed: May 12, 2025

(51) Int. Cl. G06V 10/77; G06V 10/764

(52) U.S. Cl. CPC G06V 10/7715; G06V 10/764

(57) ABSTRACT

Various embodiments of the present disclosure provide a technique for analyzing predictive feature contribution of machine learned models that improves the functionality of a computer in various aspects. The techniques comprise receiving a model output from a machine learned model, wherein (i) the model output comprises a primary prediction that is generated by the machine learned model based on a model input comprising a set of predictive features and (ii) a predictive feature of the set of predictive features corresponds to a feature source tag; generating, using an explanatory model, a set of feature contribution values for the set of predictive features with respect to the model output; generating a source contribution for the feature source tag based on the set of feature contribution values; and initiating a performance of a prediction-based task based on the source contribution and the primary prediction.

### BACKGROUND

Various embodiments of the present disclosure address technical challenges related to computer processing tasks or control system operations that rely on classifications and/or other predictions from machine learned models. Machine learned models may typically operate as “black box” systems where it may be difficult to provide interpretable insights with respect to their outputs, or how various different input features contribute to their outputs. These explainability challenges are unique to machine learning models and cause several technical challenges with downstream system that leverage such models. Unexplainable predictions, for example, may lack the context required to ensure the accuracy of the predictions and/or prevent other performance related issues, such as hallucinations, bias, and the like that may occur in traditional machine learning solutions. Additionally, technical challenges presented by the limited context provided with traditional machine learning solutions may negatively impact the performance of the systems within which they are integrated. For example, a machine learned prediction may accurately detect a default, anomaly, or other occurrence but, without context, the detection may fail to provide perceivable benefits to the downstream system. As such, it is desirable to improve explainability, efficiency, and/or reliability of machine learning solutions to both verify machine learning predictions and contextualize and inform actions taken in response to such predictions.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an example explainability integrated prediction pipeline in accordance with some embodiments of the present disclosure.

FIG. 5 depicts an operational example of source contributions in accordance with some embodiments of the present disclosure.

FIG. 6 depicts an operational example of feature contribution value aggregation in accordance with some embodiments of the present disclosure.

FIG. 7 depicts a flowchart diagram of an example prediction-based process in accordance with some embodiments of the present disclosure.

FIG. 8 depicts a flowchart diagram of an example source contribution generation process in accordance with some embodiments of the present disclosure.

FIG. 9 depicts a flowchart diagram of an example feature source tagging process in accordance with some embodiments of the present disclosure.

### DETAILED DESCRIPTION

Various embodiments of the present disclosure integrate machine learning explanation solutions into a prediction pipeline to both explain machine learning predictions and extend the predictive capabilities of a machine learned (ML) model to secondary predictions for which the ML model is untrained. Explaining machine learning predictions may include techniques (e.g., software, hardware, and/or machine learning components) to transpose machine-readable data, such as raw vectors, to human-readable text or the like, and/or to identify a subset of inputs that most strongly influenced an output by a ML model. To do so, some embodiments of the present disclosure implement a feature source tagger at an initial, or parallel, stage of the prediction pipeline to tag features within an initial model input with contextualized tags, such as feature source tags. Once tagged, individual feature contribution values may be determined for up to each feature of the model input, which may then be grouped according to their respective tags to generate secondary predictions as defined by the feature source tagger. In this way, individual feature contributions, such as SHapley Additive exPlanations (SHAP), may be mapped to a secondary prediction through feature tagging, without the use and/or training of another ML model to provide the secondary prediction. By doing so, the prediction pipeline may be extended to secondary predictions without retraining or otherwise impacting the performance of the ML model with respect to a primary prediction task. This, in turn, enables secondary predictions that may provide contextual information corresponding to a primary prediction with respect to any insight that may verify the accuracy of the primary prediction or inform a downstream action of the system within which the prediction pipeline is implemented. For example, such secondary predictions may be tailored to a downstream task, such as data retrieval task, a data filtering task, a robotic control task, or the like, to guide a downstream computing entity's and/or control system's response to a primary prediction of a ML model through an understanding of the contributing features for the primary prediction.

More particularly, as explained herein, traditional ML models, such as deep neural networks, complex decision trees, large language models (LLMs), and/or the like, are traditionally constructed as unexplainable, or “black box” architectures, where the complexities of the internal processes and logic used to generate particular outputs prevents further contextualization of the outputs. To address the explainability deficiencies of such models, feature-level explainability techniques may be applied to a model's input to detect performance deficiencies, such as bias, overfitting, and the like, based on an individual feature's contribution to a model's output. However, feature-level explainability techniques are limited to features expressed within a model input and for which the model is already trained. Thus, such techniques fail to provide interpretable insights and/or additional inputs for targeted downstream tasks that may rely on a machine learned prediction regardless of the specific features used to generate the prediction and that would be improved by additional context, like those offered by interpretable outputs of the upstream ML models. For example, in an anomaly detection use case in which a model input is aggregated from a set of disparate sources, an anomaly prediction may enable a downstream system to detect an anomaly in the set of disparate sources, but it may not direct the downstream system to the location of the anomaly.

To overcome interpretability challenges with traditional ML models and feature-level explainability techniques, the disclosed techniques preemptively tag features of a model input to allow for a downstream task-level aggregation of feature contribution values without impacting the performance of the ML model. In this way, the techniques of the present disclosure may transform feature-level contributions to task-level contributions that, in the above example, may quantify the relative importance of different data sources, rather than individual features, with respect to a prediction generated by a ML model. This, in turn, may improve the efficacy of ML models executing downstream tasks, including the prioritization and/or filtering of data for downstream prediction-based tasks, decision and control operations, and/or allocation of computational resources, among other examples.

By way of example, the techniques of the present disclosure may be integrated within a data retrieval system. For instance, a ML model may comprise an anomaly detection classifier that aggregates data from a set of different data sources to generate a machine learned output for a model input. Traditionally, in response to an anomaly detection, the data retrieval system may retrieve data from one or more data sources of the set of different data sources, transform the data into computer-readable formats, and pass the computer-readable data to a subsequent process. By implementing the techniques of the present disclosure, the data retrieval system may automatically detect a subset of one or more data sources from the set of data sources that contributes to an anomaly detection, and based on this detection, reduce the retrieval operations from the set of data sources to the one or more detected data sources. In this way, the techniques of the present disclosure may modify the initial prediction pipeline (e.g., by integrating a feature source tagger) to increase the speed and reduce memory constraints and processing resources of the data retrieval system. As described herein, the techniques of the present disclosure may be applied in various domains and use cases to improve any downstream process, including artificially intelligent robotic devices (e.g., by tagging input features with desired robotic actions), computer monitoring devices (e.g., by tagging input features with attack mitigation actions), and/or the like.

Accordingly, technical advantages provided by embodiments of the present disclosure include, but are not limited to, (i) improved reliability of machine learning predictions via explainability-integrated predictions that contextualize predictions for informing actions taken in response to such predictions, (ii) improved explainability and interpretability of a ML model output by leveraging the relative importance of different data sources, rather than individual features, with respect to a prediction generated by the ML model, and (iii) improved performance of data retrieval operations with respect to increased processing speed and reduced computing resources by determining a reduced subset of data sources that contributes to an anomaly detection, and based on this detection, confining retrieval operations to the reduced subset of data sources.

Examples of technologically advantageous embodiments of the present disclosure comprise a distribution of ML model interpretability functionality provided by the generation of source contributions that improves the functionality of a computing entity or control system in various decision and control contexts, such as robotic devices, autonomous vehicles, process control system, building automation system, and/or signaling systems.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

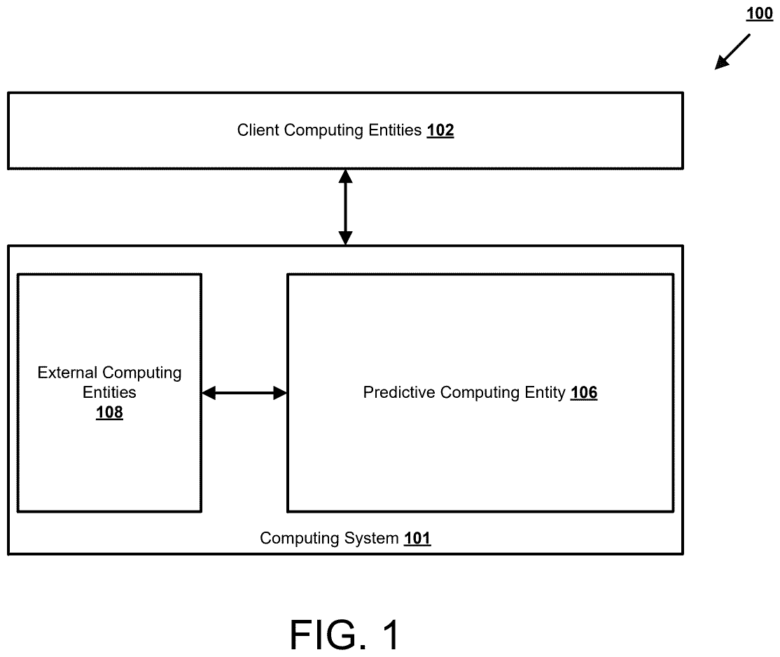

FIG. 1 depicts a block diagram of an example architecture 100 in accordance with some embodiments of the present disclosure. The architecture 100 comprises a computing system 101 configured to receive a request, such as a model input, and/or the like, from client computing entities 102, process the request, and provide a model output, a source contribution, and/or a control signal to the client computing entities 102. The example architecture 100 may be used in a plurality of domains and not limited to any specific application as disclosed herewith. The plurality of domains may comprise healthcare, industrial, manufacturing, public infrastructure, computer security, and/or the like to name a few. In accordance with various embodiments of the present disclosure, one or more ML models may be trained to generate candidate outputs, candidate output scores, and/or other machine learned outputs.

In some embodiments, the computing system 101 communicates with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive a request, such as a model input, and/or the like, from client computing entities 102, process the request, and provide a model output, a source contribution, and/or a control signal to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, up to each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate ML models in accordance with one or more training and/or inference operations of the present disclosure. In some examples, the one or more external computing entities 108 may be configured to train, implement, use, update, and evaluate ML models in accordance with one or more training and/or inference operations of the present disclosure.

In some embodiments, the predictive computing entity 106 is configured to receive and/or transmit one or more datasets, objects, and/or the like from and/or to the one or more external computing entities 108 to perform one or more steps/operations of one or more techniques (e.g., source contribution generating and/or feature source tagging) described herein. The one or more external computing entities 108, for example, may comprise and/or be associated with one or more entities that may be configured to receive, transmit, store, manage, and/or facilitate datasets, and/or the like. The one or more external computing entities 108, for example, may comprise data sources that may provide such datasets, and/or the like to the predictive computing entity 106 which may leverage the datasets, such as predictive feature datasets, to perform one or more steps/operations of the present disclosure, as described herein. In some examples, the datasets may comprise an aggregation of data from across the one or more external computing entities 108 into one or more aggregated datasets. The one or more external computing entities 108, for example, may be associated with one or more data repositories, cloud platforms, compute nodes, organizations, and/or the like, which may be individually and/or collectively leveraged by the predictive computing entity 106 to obtain and/or aggregate data for an information domain.

In some embodiments, the predictive computing entity 106 is configured to receive a ML model that is trained and subsequently provided by the one or more external computing entities 108. For example, the one or more external computing entities 108 may be configured to perform one or more training steps/operations of the present disclosure to train a machine learning model, as described herein. In such a case, the trained ML model may be provided to the predictive computing entity 106, which may leverage the trained ML model to perform one or more inference steps/operations of the present disclosure. In some examples, feedback (e.g., evaluation data, ground truth data) from the use of the ML model may be received and/or stored by the predictive computing entity 106. In some examples, the feedback may be provided to the one or more external computing entities 108 to continuously train the ML model over time. In some examples, the feedback may be leveraged by the predictive computing entity 106 to continuously train the ML model over time. In this manner, the computing system 101 may perform, via one or more combinations of computing entities, one or more prediction, training, and/or any other machine learning-based techniques of the present disclosure.

### A. Example Computing Entity

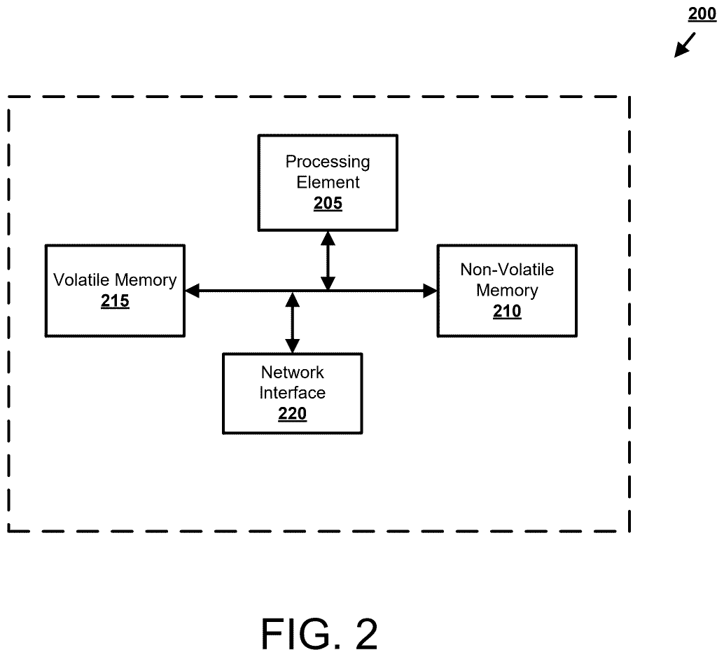

FIG. 2 depicts a block diagram of an example computing entity 200 in accordance with some embodiments of the present disclosure. The computing entity 200 is an example of the predictive computing entity 106 and/or the one or more external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more ML models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) trains and uses one or more ML models described herein. In other embodiments, a first computing entity (e.g., predictive computing entity 106, which may be one or more predictive computing entities) uses one or more ML models that may be trained by a second computing entity (e.g., the one or more external computing entities 108) communicatively coupled to the first computing entity. The second computing entity, for example, may train one or more of the ML models described herein, and subsequently provide the trained ML model(s) (e.g., optimized weights, code sets) to the first computing entity over a network.

As shown in FIG. 2, in some embodiments, the computing entity 200 comprises, or is in communication with, a processing element 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 further comprises, or is in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 comprises a computer-readable storage medium that may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 comprises a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilizes quantum bits, or qubits, which may exist in multiple states simultaneously through a property called superposition. Unlike classical bits that may only be in a state of 0 or 1, qubits may represent both states at once, allowing for exponentially greater quantities of information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more ML models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more ML models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

In some embodiments, one or more components of the present disclosure are implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computing entity 200 may be specialized for machine learning tasks. By way of example, LLMs and other transformer networks may be specially designed for operation within a quantum environment by replacing weight matrices in self-attention and/or multi-layer perceptron layers of such models with one or more combinations of variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 also comprises one or more network interfaces 220 for communicating with various computing entities (e.g., the client computing entities 102, the one or more external computing entities 108), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more ML models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

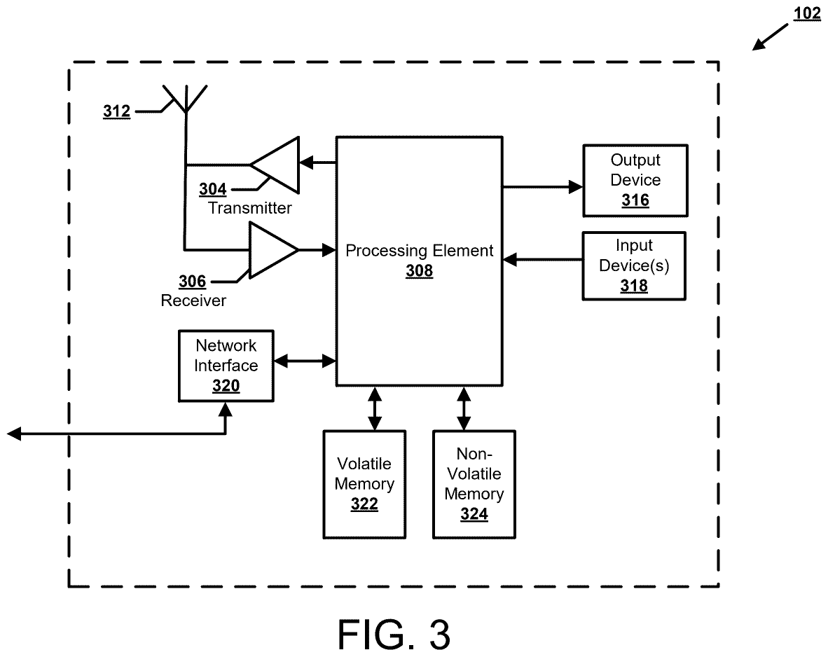

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 comprises location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the one or more external computing entities 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more ML models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 comprises one or more components or functionalities that are the same or similar to those of the computing entity 200, as described in greater detail above. In one such embodiment, the client computing entity 102 downloads, e.g., via network interface 320, code embodying ML model(s) from the computing entity 200 so that the client computing entity 102 may run a local instance of the ML model(s). As will be recognized, these architectures and descriptions are provided for example purposes only and are not limited to the various embodiments.

In various embodiments, the client computing entity 102 is embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity is configured to retrieve and/or execute one or more of the predefined program algorithms upon the occurrence of a predefined trigger event.

### III. Example System Operations

As indicated, various embodiments of the present disclosure make important technical contributions to control systems, computer resource allocation, and other tasks downstream from a ML model. In particular, systems and methods are disclosed herein that implement techniques to improve predictive feature contribution analysis of ML models that are used in downstream computing processes and/or systems. By doing so, the disclosed techniques of the present disclosure enable improved control system processes, computer resource allocation, data retrieval, among other tasks, by extending the predictive capacity of a ML model to task-level predictions for which the model is untrained. This, in turn, may improve the functionality of a computer with respect to various prediction-based computing tasks, comprising data security, process control operations, autonomous vehicle controls, building automation, signaling, and/or the like.

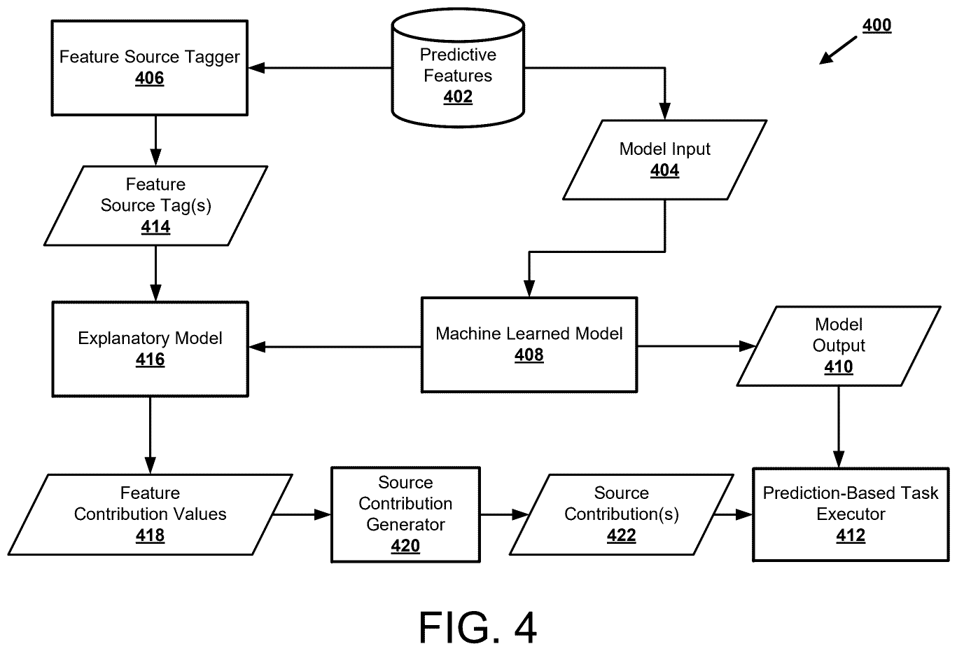

FIG. 4 depicts a dataflow diagram 400 of an example explainability integrated prediction pipeline in accordance with some embodiments of the present disclosure. A computing system, such as the computing system 101 described herein, may implement the explainability integrated prediction pipeline to improve the explainability and interpretability of a model output 410 with respect to a particular downstream task tailored to a prediction-based task executor 412. To do so, the computing system 101 may integrate a feature source tagger 406 within the prediction pipeline to tag predictive features 402 of a model input 404 with one or more feature source tags 414 corresponding to a downstream action by the prediction-based task executor 412. By doing so, the computing system 101 may aggregate feature contribution values 418 at a level of a source contribution 422 that may be reflective of an actionable, secondary prediction with respect to the model output 410.

In some embodiments, the computing system 101 extracts predictive features 402 from data received from one or more data sources and aggregated into a database. For example, values, codes, or attributes may be extracted from raw data (e.g., diagnostic data) and aggregated into the predictive features 402. In some embodiments, the predictive features 402 are grouped into plurality of temporally aggregated feature occurrences based on entity, date, and/or any other criteria of which the predictive features 402 pertain to. As such, the predictive features 402 may be aggregated in a manner that provides an encapsulation of activities for a given entity for a particular time window.

Model input 404 is generated from the predictive features 402 and provided to a ML model 408. The ML model 408 may be trained to generate a prediction for the model input 404 and provide the prediction as a model output 410. In some embodiments, the model output 410 comprises a probability or confidence score. The model output 410 is provided by the ML model 408 to a prediction-based task executor 412 (e.g., a component of the computing system 101, such as the predictive computing entity 106 and/or the one or more external computing entities 108). In some embodiments, the model output 410 comprises a primary prediction that is used by the prediction-based task executor 412 to perform downstream prediction-based tasks, decision and control operations, and/or allocation of computational resources. The prediction-based task executor 412 may comprise a computing entity or control system in various decision and control contexts, such as robotic devices, autonomous vehicles, process control system, building automation system, and/or signaling systems. The prediction-based task executor 412 is also provided with source contribution 422 that is generated by a source contribution generator 420. In some embodiments, the prediction-based task executor 412 uses the source contribution 422 to provide context for model output 410 in performing downstream prediction-based tasks, decision and control operations, and/or allocation of computational resources. In some embodiments, the prediction-based task executor 412 comprises a secondary ML model that is configured to generate a secondary prediction based on the primary prediction and the source contribution 422.

One or more feature source tags 414 are generated for the predictive features 402 and provided to an explanatory model 416. The one or more feature source tags 414 may be used to identify data sources that are associated with predictive features 402. The explanatory model 416 may be configured to observe individual contributions of predictive features from the model input 404 in generating the model output 410. The one or more feature source tags 414 may be used by the explanatory model 416 to generate feature contribution values 418 for the predictive features 402 with respect to the model output 410.

The feature contribution values 418 are provided to the source contribution generator 420 to generate the source contribution 422. In some embodiments, the source contribution 422 is generated by aggregating the feature contribution values 418 according to feature source tag, prediction target, and/or time window. For example, a source contribution 422 may be generated for a feature source tag of the one or more feature source tags 414 by aggregating a subset of the feature contribution values 418 that corresponds to the feature source tag, a particular prediction, and/or for a particular time window. Additionally, or alternatively the source contribution 422 may be generated for the feature source tag of the one or more feature source tags 414 by aggregating the subset of the feature contribution values 418 that corresponds to a location, identifier, or any unique feature identifying and/or describing the feature source tag.

In some embodiments, the prediction-based task executor 412 is configured to (i) prioritize specific processes based on a prediction provided by the model output 410 and (ii) rank and/or target one or more data sources associated with the one or more feature source tags 414 for the specific processes based on the source contribution 422. In some embodiments, a source contribution 422 comprises a score for data source that is associated with a prediction target, an entity associated with the prediction target, and a time window. Accordingly, top scoring source contributions (e.g., of source contribution(s) 422) may be targeted by the prediction-based task executor 412. In this way, the relative importance of different data sources in predictions generated by ML models (e.g., ML model 408) may be provided to and used by a downstream computing entity and/or control system to effectively prioritize and/or filter data for downstream prediction-based tasks, decision and control operations, and/or allocation of computational resources based on the relative importance of different data sources.

In some embodiments, the model output 410 comprises a primary prediction that is received from the ML model 408. In some embodiments, using the explanatory model 416, a set of the feature contribution values 418 is generated for a set of the predictive features 402 with respect to the model output 410. In some embodiments, a source contribution 422 is generated for a feature source tag of the one or more feature source tags 414 based on the set of the feature contribution values 418. In some embodiments, a performance of a prediction-based task based on the source contribution 422 and the primary prediction is initiated.

In some embodiments, the prediction-based task comprises (i) receiving a dataset that is associated with the primary prediction and a set of the one or more feature source tags 414 and (ii) determining, based on the source contribution 422, a data subset of the dataset, wherein the data subset is associated with the one or more feature source tags 414. The dataset may comprise data in the form of text, images, audio, and/or data files. In some embodiments, the data subset comprises a subset of images from the dataset and the prediction-based task comprises (i) filtering the subset of images from the dataset based on the one or more feature source tags 414 and (ii) inputting the subset of images to an image-based ML model 408 to extract targeted data for the model output 410.

In some embodiments, a model output 410 comprises data that is generated by a ML model 408 based on a model input 404. For example, responsive to a model input 404 provided to a ML model 408, the ML model 408 may execute a machine learning algorithm to generate a model output 410. A model output 410 may be used as a basis for providing predictions and/or control signals (e.g., to control another device, computing entity, and/or system) by a computing entity. For example, in a healthcare context, a model output 410 may comprise a prediction (and/or control signal corresponding to a prediction-based action) of whether a patient has a certain medical condition (e.g., diabetes with chronic complication) based on symptoms and/or test results provided to a ML model 408 as model input 404. As another example, in a cybersecurity context, a model output 410 may comprise a prediction (and/or control signal corresponding to a prediction-based action) of whether a computing system and/or entity has a certain vulnerability based on operating characteristics and/or configurations of the computing system and/or entity that are provided to a ML model 408 as model input 404.

A model output 410 may be provided as a probability score, a binary classification, and/or a more sophistical data structure depending on a specific application. In some embodiments, a model output 410 is further processed and/or analyzed to extract additional insights, which involve techniques, such as feature importance analysis or model interpretation to determine how different predictive features 402 of data processed by a ML model contributed to a model output 410. In some embodiments, a model output 410 is provided as input to other ML models, data processing systems, and/or actuators as part of a predictive analysis and/or control system.

In some embodiments, a model input 404 comprises data that is provided to a ML model 408 to generate a model output 410. A model input 404 may comprise one or more predictive features 402 that may be used by a ML model 408 to generate a prediction and/or model output 410. As such, a model input 404 may provide meaningful information that a ML model 408 may use to generate a model output 410. For example, in a healthcare context, a model input 404 may comprise codes (e.g., diagnosis-related group (DRG), international classification of diseases (ICD), current procedural terminology (CPT), national drug code (NDC), logical observation identifiers names and codes (LOINC)) that describe patient symptoms, lab test results, and medical history, which a ML model 408 may use to predict a likelihood of various conditions. As another example, in a cybersecurity context, a model input 404 may comprise operating characteristics and/or system performance data (e.g., performance metrics, system status, and/or data logs), which a ML model 408 may use to predict a likelihood of various vulnerabilities.

A model input 404 may comprise text, images, audio, and/or data files that comprise extractable predictive features 402. In some embodiments, raw data is prepared and/or transformed into a format suitable to be provided as model input 404 to a ML model 408 and/or used by a machine learning algorithm of the ML model 408 to generate predictions. For example, data preprocessing, such as normalization, feature encoding, handling missing data (e.g., imputation and/or data removal), and/or feature engineering, may be performed on a model input 404 prior to providing the model input 404 to a ML model 408. In some embodiments, a model input 404 is structured to include temporal and/or sequential information, such as time series data or sequences of events, which facilitates capturing of patterns and/or relationships that evolve over time by time-based ML models, such as recurrent neural networks (RNNs), long short-term memory (LSTM), and/or gradient boosted trees. In some embodiments, a model input 404 is augmented with metadata, such as feature source tag(s) 414s, that is used by an explanatory model 416 to generate feature contribution values 418 and/or provide explanatory output of predictions generated by ML model 408 provided with the model input 404.

In some embodiments, a ML model 408 comprises a data construct that learns, based on a machine learning algorithm, patterns from a training dataset and uses the learned patterns to generate model outputs (e.g., model output 410) based on respectively corresponding model inputs (e.g., model input 404). A ML model 408 may be stored in computer memory as a set of parameters and/or weights that may define the behavior of ML model 408 and may be adjusted based on a training dataset during a training process. ML model 408 may be implemented as computer programs or software modules that may be executed on computer hardware. Examples of ML model 408 include neural networks, decision trees, random forests, or support vector machines. In some embodiments, a ML model 408 comprises a time-based ML model, such as RNN, LSTM, and/or gradient boosted trees. In some embodiments, techniques, such as transfer learning, may be used to allow knowledge from a first ML model 408 to be applied to a different but related prediction-based task (e.g., of a second ML model), thereby improving the performance or reducing an amount of computations and/or processing (e.g., training data required by a second ML model) that are performed by a computing entity. In some embodiments, a ML model 408 is configured to generate control signals for devices and/or systems, such as robotic devices, autonomous vehicles, process control system, building automation system, and/or traffic control systems.

In some embodiments, a prediction comprises a model output 410 that is generated by a ML model 408, wherein the ML model 408 is trained to use patterns learned from a training dataset to generate the prediction for input predictive features 402 from a model input 404. A process for generating a prediction may comprise executing, by one or more processors, a ML model 408 stored in memory to perform calculations as defined by the ML model 408. A prediction may comprise a probability score, a class label, or a numeric value, depending on the nature of a prediction task associated with the prediction.

In some embodiments, a primary prediction comprises a prediction that provides a basis for the performance of one or more subsequent processes or prediction-based tasks. A primary prediction may comprise a model output 410 generated by a ML model 408, representing a best estimate or classification made by ML model 408 for a given model input 404. For example, in a healthcare context, a primary prediction may comprise a likelihood of a patient having a particular condition. As another example, in a cybersecurity context, a primary prediction may comprise a likelihood of a computing system and/or entity having a particular vulnerability.

A primary prediction may serve as a decision point in control systems, where the primary prediction may form the basis for subsequent actions, such as controlling a computing entity to perform additional tests, provide treatments/solutions, and/or generate outputs (e.g., alarm, communication, and/or user interface elements). Accordingly, the accuracy and reliability of primary predictions may be important to overall performance of a system. In some embodiments, primary predictions may be used as inputs to other ML models and/or predictive analysis system, forming part of a larger prediction pipeline.

In some embodiments, a predictive feature (e.g., of predictive features 402) comprises a characteristic of data that is provided to and used by a ML model 408 to learn and/or generate predictions. Predictive features 402 may comprise individual components and/or attributes of data, such as model input 404, that a ML model 408 uses to generate predictions. That is, predictive features 402 may be used by machine learning algorithms to identify patterns and relationships in data that are predictive of a target variable. For example, during a training process, a ML model 408 may learn to assign weights and/or importance to predictive features 402 of training data based on their predictive power and use the assigned weights or importance to make predictions for inference input data (e.g., model input 404). A predictive feature may be numerical, categorical, or more complex (e.g., text and/or images). The importance of, or contribution of, different predictive features 402 to model output 410 generated by a ML model 408 may be of interest. For example, feature contribution values 418 may be used to quantify and/or interpret the impact of individual predictive features 402 on predictions generated by the ML model 408, which be used to identify the most influential factors (e.g., data sources) in the predictions.

In some embodiments, a feature source tag 414 comprises an identifier of a data source associated with a predictive feature. A feature source tag 414 may be used to associate predictive features 402 of a model input 404 with a data source. In some embodiments, a feature source tag 414 describes a category or grouping of predictive features 402 that corresponds to a data source. For example, in a healthcare context, a feature source tag 414 may indicate whether a particular piece of patient data (e.g., a diagnostic and/or treatment code) originated (e.g., treated and/or documented) from a primary care physician, a healthcare specialist, or a hospital. As another example, in a cybersecurity context, a feature source tag 414 may indicate whether particular operating characteristic and/or system performance data (e.g., a diagnostic and/or error code) originated (e.g., measured and/or communicated) from a particular hardware device, software program, or process.

In some embodiments, a predictive feature of a set of predictive features 402 (e.g., provided as model input 404) is assigned a particular feature source tag 414. In some embodiments, assigning a predictive feature with a feature source tag 414 comprises (i) determining a data source that is associated with the predictive feature and (ii) assigning the predictive feature with a feature source tag 414 that corresponds to the data source. In some embodiments, determining a data source that is associated with a predictive feature comprises traversing a set of data source rules. For example, in a healthcare context, (A) pharmacy claims, lab claims, and/or medical supplies/equipment may be associated with ordering/prescribing physicians, (B) office visits may be associated with rendering physicians, and (C) hospital visits, where a patient may be potentially treated by many providers, may be associated with billing providers. As another example, in a computer architecture context, (A) power consumption and/or execution time may be associated with processors, (B) memory usage may be associated with a software programs or processes, and (C) latency, throughput, bandwidth, and/or packet loss may be associated with network devices. Accordingly, a predictive feature may be assigned with a feature source tag 414 based on the data source rules.

In some embodiments, predictive features 402 within a model input 404 are encapsulated with feature source tag(s) 414 to delineate predictive features 402 that are associated with a plurality of data sources. A feature source tag 414 may comprise string labels and/or unique characters that are inserted into (e.g., a file, data sequence, and/or data stream of) and/or appended next to predictive features 402 of a model input 404. Feature source tag(s) 414 may be used to (i) filter or segment data based on data source, (ii) weight predictive features 402 differently based on reliability of data sources, and/or (iii) provide explanations for predictions generated by ML model 408 by referencing data sources of influential predictive features 402. In some embodiments, feature source tag(s) 414 are used to determine load balancing, task scheduling, and/or resource allocation of servers, ensuring that data from certain data sources are processed in appropriate contexts and/or with appropriate priority.

In some embodiments, an explanatory model 416 comprises a data construct that is configured to provide insights into how a ML model 408 generates its predictions by identifying and/or quantifying the impact of individual predictive features 402 on the model output 410 of ML model 408. For example, an explanatory model 416 may generate feature contribution values 418 that describe how much specific predictive features 402 contribute to a model output 410 generated by a ML model 408. In some embodiments, an explanatory model 416 is based on feature contribution values 418, such as SHAP values (e.g., a tree SHAP model), which use concepts from game theory to assign importance values to each predictive feature for a particular prediction. Alternatively, an explanatory model 416 may be based on local interpretable model-agnostic explanations (LIME), equal surplus(ES), feature-based explainable surrogate prediction (FESP), partial dependence plots (PDPs), accumulated local effects (ALE) plots, individual conditional expectation (ICE) plots. An explanatory model 416 may comprise a supervised or semi-supervised machine learning model, such as a neural network, a decision tree, a random forest, a support vector machine, an autoencoder, or a transformer, to name a few.

An explanatory model 416 may be used to increase the transparency and interpretability of machine learning systems, particularly in domains where understanding the reasoning behind predictions may be important. For example, in a healthcare context, an explanatory model 416 may be used to identify which symptoms or test results were most influential in a diagnosis prediction, which may be valuable for healthcare providers in verifying a reasoning of the ML model 408 for making informed healthcare decisions. As another example, in a cybersecurity context, an explanatory model 416 may be used to identify which operating characteristic and/or system performance data were most influential in a vulnerability prediction, which may be valuable for system administrators in verifying a reasoning of the ML model 408 for making informed security decisions.

In some embodiments, output of explanatory model 416, such as feature contribution values 418, is used as part of a feedback loop to refine and improve a primary ML model 408 (e.g., that generates primary predictions) and/or another ML model (e.g., associated with a prediction-based task executor 412 that is configured to perform prediction-based tasks based on primary predictions) that is downstream of the primary ML model 408.

In some embodiments, a feature contribution value 418 comprises a value that describes a degree to which a corresponding predictive feature contributes to a prediction (i.e., model output 410) generated by a ML model 408. That is, a feature contribution value 418 may quantify an impact or importance of an individual predictive feature from a model input 404 on a particular prediction generated by a ML model 408, thereby providing a measure of how much the individual predictive feature influenced the ML model 408 to generate the particular prediction. Feature contribution values 418 may be used to provide interpretability and explainability for ML model 408, such as by describing why a ML model 408 generated a particular prediction and which predictive features 402 were most influential in the prediction. In some embodiments, a feature contribution value 418 comprises a SHAP value. A feature contribution value 418 may be numerical and comprise either a positive or negative value, indicating whether a predictive feature contributed positively or negatively to a prediction. In addition, or alternatively, feature contribution values 418 may also be used as inputs to other models (e.g., associated with prediction-based tasks) or control system decision-making processes.

In some embodiments, a source contribution 422 comprises a metric that describes an overall contribution of a data source, based on an aggregate of feature contribution values 418 for a feature source tag 414 corresponding to the data source, to a prediction (i.e., model output 410) generated by a ML model 408. A source contribution 422 may be used to understand the relative importance of different data sources in a prediction generated by ML model 408. This may be particularly valuable where model input 404 provided to a ML model 408 may comprise data that is aggregated from multiple data sources, as source contribution(s) 422 may provide insights into which data sources are most influential for different types of predictions. For example, in a healthcare context, source contribution(s) 422 may identify whether patient data (e.g., diagnostic or treatment code) from a primary care physician, a healthcare specialist, or a hospital, tends to be more important for predicting certain conditions. As another example, in a cybersecurity context, source contribution(s) 422 may identify whether particular operating characteristic and/or system performance data (e.g., diagnostic or error code) reported from a particular hardware device, software program, or process, tends to be more important for predicting certain vulnerabilities. Accordingly, source contribution(s) 422 may provide a higher-level view of how different data sources influence model predictions by combining feature contribution values 418 for a set of predictive features 402 that originate from a same data source.

In some embodiments, generating a source contribution comprises aggregating feature contribution values 418, such as SHAP values, of predictive features 402 from a model input 404, wherein the predictive features 402 are associated with a particular data source. Aggregating feature contribution values 418 may comprise statistical operations, such as determining a sum, an average, a median, a maximum, a minimum, or a weighted average of feature contribution values 418.

In some embodiments, a source contribution is used to provide a basis for initiating a performance of a downstream process of a predictive analysis and/or control system. For example, a downstream process may comprise a prediction-based task that prioritizes data sources that have high-valued source contributions to a particular primary prediction. As another example, a downstream process may comprise ingesting a set of raw image (or text, audio, etc.) data, prioritizing, filtering, and/or processing (e.g., data extraction, optical character recognition (OCR), and/or feature detection) at least a portion of image data based on a source contribution.

In some embodiments, a prediction-based task comprises a downstream operation that is dependent on and/or performed in the context of a primary prediction. For example, a prediction-based task may use a prediction of ML model 408 as a basis for making decisions, taking actions, or performing further analyses. In some embodiments, a prediction-based task comprises one or more actions and/or processes that are initiated and/or guided by a model output 410 (e.g., primary prediction) of a ML model 408. Accordingly, prediction-based tasks may be used to operationalize insights gained from ML model 408 and translate predictions (e.g., primary predictions) generated by ML model 408 into concrete actions or decisions within a larger predictive analysis and/or control system. For example, in a healthcare context, prediction-based tasks may include load balancing of servers, allocating computing resources, and/or prioritizing tasks for execution by the servers to ensure that data retrieved from certain healthcare provider data sources are processed accordingly based on a primary prediction of a particular medical condition. As another example, in a cybersecurity context, prediction-based tasks may include load balancing of servers, allocating computing resources, and/or prioritizing tasks for execution by the servers to ensure that certain hardware devices, software programs, or processes are diagnosed accordingly based on a primary prediction of a particular vulnerability.

In some embodiments, a prediction-based task comprises reducing, filtering, and/or prioritizing data and/or file volumes for retrieval and/or processing. In some embodiments, a prediction-based task comprises controlling robots to perform complex tasks, such as manipulation and navigation. In some embodiments, a prediction-based task comprises controlling self-driving cars and/or other autonomous systems. In some embodiments, a prediction-based task comprises optimizing the performance of industrial processes, such as chemical plants and power plants. In some embodiments, a prediction-based task comprises controlling building systems, such as heating, ventilation, and air conditioning (HVAC). In some embodiments, a prediction-based task comprises controlling traffic signals and/or optimizing traffic flow.

In some embodiments, temporally aggregated feature occurrences comprise instances of predictive features 402 that are grouped in accordance with one or more time windows. A time window may comprise a duration of time, such as a plurality of days, weeks, months, or a year. For example, a model input 404 may comprise predictive features 402 that are provided as raw time-stamped data, where the predictive features 402 may be grouped into defined time windows that are associated with distinct incidents or observation periods. In some embodiments, temporally aggregated feature occurrences are generated by identifying and clustering predictive features 402 within a model input 404 based on specific time windows. Accordingly, temporally aggregated feature occurrences may be used to capture time-dependent patterns in data that may be relevant for prediction tasks. In some embodiments, clustering of predictive features 402 and/or determination of time windows for generating temporally aggregated feature occurrences are performed by an unsupervised ML model. In some embodiments, time windows for temporally aggregated feature occurrences are optimized and/or fine-tuned based on based on historical predictions generated with historical temporally aggregated feature occurrences. By aggregating over appropriate time windows, predictive features 402 may be collectively analyzed (e.g., by a ML model 408) within a same context.

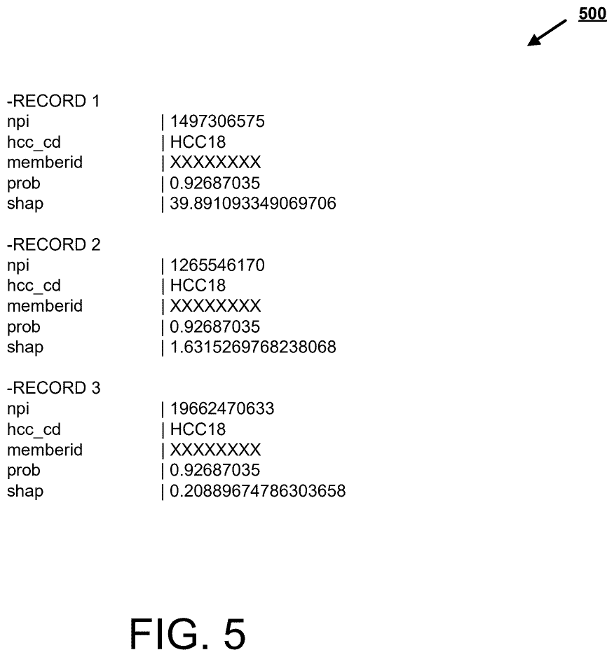

FIG. 5 depicts an operational example 500 of source contributions in accordance with some embodiments of the present disclosure. An explanatory model (e.g., explanatory model 416) may generate a plurality of source contribution for a plurality of corresponding feature source tags, as shown by the plurality of records in the operational example 500. A record of the depicted plurality of records describes a distinct feature source tag (“npi”), a prediction target (“hcc_cd”), an entity associated with the prediction target (“memberid”), a prediction probability or score of the prediction target (“prob”), and a data source feature contribution value (“shap”).

The data source feature contribution value may comprise a value that is based on one or more feature contribution values of one or more distinct predictive features that are associated with the distinct feature source tag. For example, a set of distinct predictive features of a plurality of distinct predictive features may correspond to a same feature source tag, and as such, a data source feature contribution value for the feature source tag may comprise a combination (e.g., sum, average, a median, a maximum, a minimum, or a weighted average) of a plurality of feature contribution values that corresponds to the set of distinct predictive features. Thus, a data source associated with a feature source tag that has a high proportion of feature contribution values for a particular prediction generated by a ML model may likely be a primary contributor to the prediction.

In this way, the relative importance of particular data sources contributing to predictions generated by ML models (e.g., ML model 408) may be determined to enable more effective prioritization and/or filtering of data for downstream prediction-based tasks, decision and control operations, and/or allocation of computational resources.

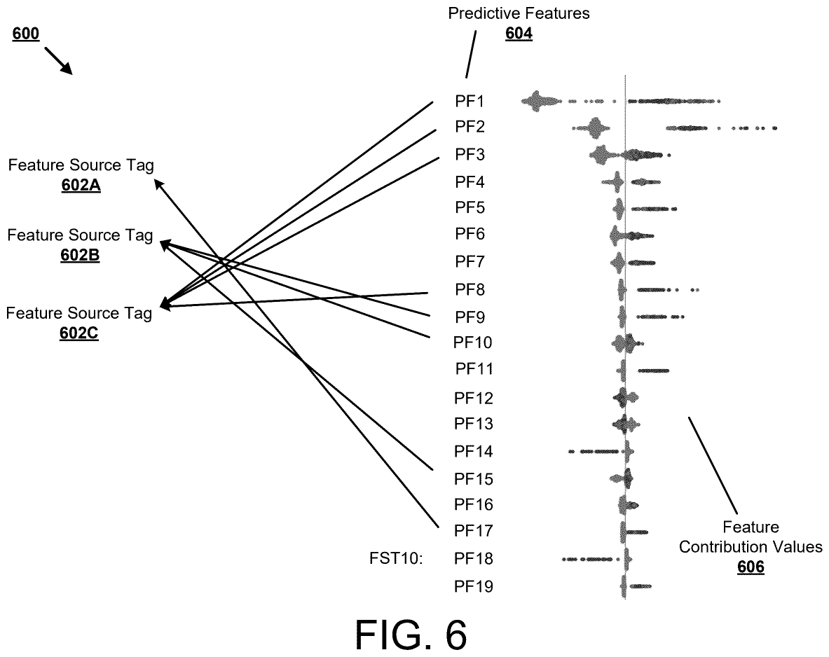

FIG. 6 depicts an operational example 600 of feature contribution value aggregation in accordance with some embodiments of the present disclosure. As shown in the operational example 600, feature contribution values 606 are determined for predictive features 604. The predictive features 604 may comprise predictive features of a model input (e.g., model input 404) that are provided to a ML model (e.g. ML model 408) that are used to generate a model output (e.g., model output 410). The feature contribution values 606 may comprise feature contribution values that describe a contribution of the predictive features 604 on the model output. Accordingly, the predictive features 604 are respectively mapped to feature source tag 602A, feature source tag 602B, and feature source tag 602C. The feature source tags 602A, 602B, and 602C may be used to generate source contributions (e.g., source contribution 422) for data sources that respectively correspond to the feature source tags 602A, 602B, and 602C. In this way, source contributions may be generated that quantify the relative importance of different data sources in predictions generated by ML models to enable more effective prioritization and/or filtering of data for downstream prediction-based tasks, decision and control operations, and/or allocation of computational resources based on the relative importance of different data sources.

In some embodiments, (i) a source contribution comprises a first source contribution that corresponds to a first feature source tag (e.g., feature source tag 602A) of the set of the feature source tags (602A, 602B, 602C), (ii) a subset of a set of the predictive features 604 comprises a first subset of predictive features that corresponds to the first feature source tag, and (iii) the set of the predictive features 604 comprises a second subset of predictive features corresponding to a second feature source tag (e.g., feature source tag 602B) of the set of the feature source tags (602A, 602B, 602C). In some embodiments, (a) a second source contribution for the second feature source tag is generated by aggregating a second subset of a set of the feature contribution values 606 that correspond to the second subset of predictive features and (b) a secondary prediction is determined for a primary prediction based on the first source contribution and the second source contribution. In some embodiments, the feature source tags (602A, 602B, 602C) correspond to a subset of predictive features of the set of the predictive features 604 and a source contribution is determined by aggregating a subset of the set of the feature contribution values 606 that correspond to the subset of predictive features.

In some embodiments, the ML model is a time-agnostic model, the model input comprises a plurality of feature occurrences of a data source predictive feature within the subset of predictive features, and aggregating the subset of the set of the feature contribution values 606 comprises (a) generating an overall feature contribution value for the data source predictive feature by scaling a data source feature contribution value of the subset of the set of the feature contribution values 606, wherein the data source feature contribution value corresponds to the data source predictive feature based on the plurality of feature occurrences of the data source predictive feature and (b) generating the source contribution based on the overall feature contribution value. In some embodiments, the ML model is a time-based model and the set of the feature contribution values 606 comprises a particular feature contribution value for each feature occurrence of the predictive feature within the model input. In some embodiments, a feature contribution value of the set of the feature contribution values 606 comprises a SHAP value.

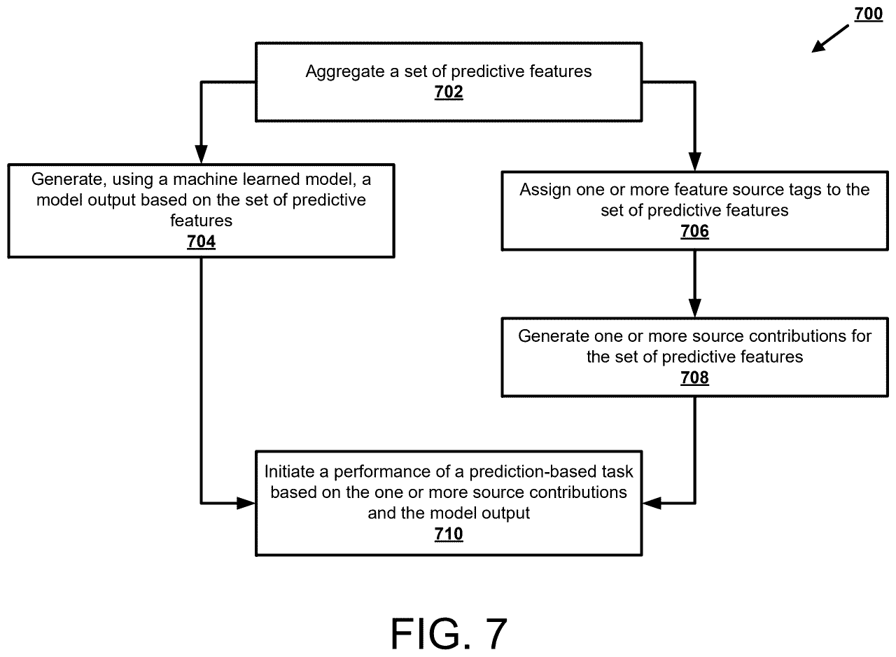

FIG. 7 depicts a flowchart diagram of an example prediction-based process 700 in accordance with some embodiments of the present disclosure. The flowchart diagram depicts a prediction-based process that analyzes a ML model's behavior to improve performance of downstream computing entity and/or control system processes that are based on predictions generated by the ML model. The process 700 may be implemented by one or more computing devices, entities, and/or systems described herein. For example, via the various steps/operations of the process 700, the computing system 101 may generate a source contribution for a set of predictive features associated with a prediction (i.e., model output) generated by a ML model and use the source contribution along with the prediction to perform a prediction-based task. By doing so, the process 700 improves computer functionality by improving prioritization and/or filtering of data for downstream prediction-based tasks, decision and control operations, and/or allocation of computational resources.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 comprises, at operation 702, aggregating a set of prediction features. For example, the computing system 101 may aggregate a set of prediction features.

In some embodiments, the process 700 comprises, at operation 704, generating, using a ML model, a model output based on the set of predictive features. For example, the computing system 101 may generate, using a ML model, a model output based on the set of predictive features. In some embodiments, the model output comprises a primary prediction that is generated by the ML model based on a model input comprising the set of predictive features.

In some embodiments, the process 700 comprises, at operation 706, assigning one or more feature source tags to the set of predictive features. For example, the computing system 101 may assign one or more feature source tags to the set of predictive features. In some embodiments, a predictive feature of the set of predictive features corresponds to a feature source tag of the one or more feature source tags.

In some embodiments, the process 700 comprises, at operation 708, generating one or more source contributions for the set of predictive features. For example, the computing system 101 may generate one or more source contributions for the set of predictive features.

In some embodiments, the process 700 comprises, at operation 710, initiating a performance of a prediction-based task based on the one or more source contributions and the model output. For example, the computing system 101 may initiate a performance of a prediction-based task based on the one or more source contributions and the model output.

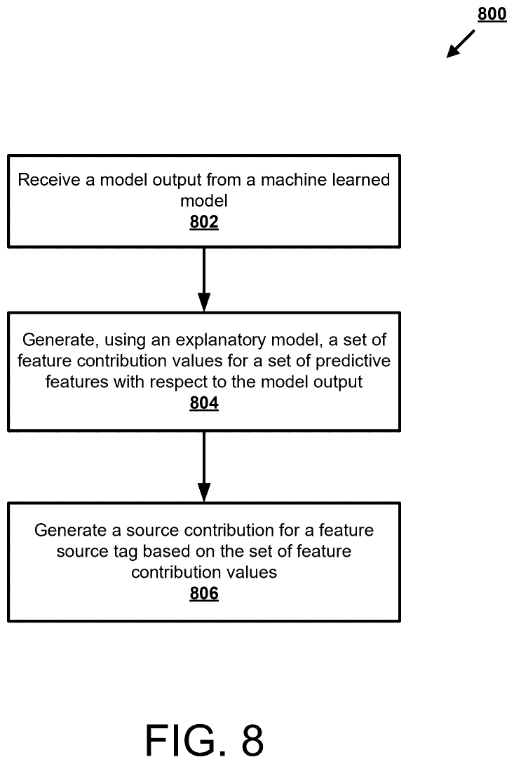

FIG. 8 depicts a flowchart diagram of an example source contribution generation process 800 in accordance with some embodiments of the present disclosure. The flowchart diagram depicts a source contribution generation process that quantifies the relative importance of different data sources in predictions generated by ML models, thereby providing interpretability and explainability for the ML models and identifying the most influential factors (e.g., data sources) in the predictions. The process 800 may be implemented by one or more computing devices, entities, and/or systems described herein. For example, via the various steps/operations of the process 800, the computing system 101 may generate a source contribution for a feature source tag based on feature contribution values for predictive features that contribute to a prediction (i.e., model output) generated by ML model. By doing so, the process 800 improves computer functionality by improving prioritization and/or filtering of data for downstream prediction-based tasks, decision and control operations, and/or allocation of computational resources based on the relative importance of different data sources.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, receiving a model output from a ML model. For example, the computing system 101 may receive a model output from a ML model.

In some embodiments, the process 800 comprises, at operation 804, generating, using an explanatory model, a set of feature contribution values for a set of predictive features with respect to the model output. For example, the computing system 101 may generate, using an explanatory model, a set of feature contribution values for a set of predictive features with respect to the model output.

In some embodiments, the process 800 comprises, at operation 806, generating a source contribution for a feature source tag based on the set of feature contribution values. For example, the computing system 101 may generate a source contribution for a feature source tag based on the set of feature contribution values.

In some embodiments, the set of predictive features comprises a plurality of temporally aggregated feature occurrences that is received from a set of data sources, wherein the set of data sources corresponds to a set of feature source tags. In some embodiments, based on the set of data sources, a tagged model input is generated by encapsulating, with the feature source tag, an occurrence of a predictive feature of the set of predictive features within a model input based on a data source of the set of data sources that originates the occurrence of the predictive feature. In some embodiments, (i) the plurality of temporally aggregated feature occurrences describes one or more actions that are associated with (a) one or more data sources of the set of data sources and (b) one or more time windows and (ii) the one or more actions are directed at a target entity associated with the primary prediction.

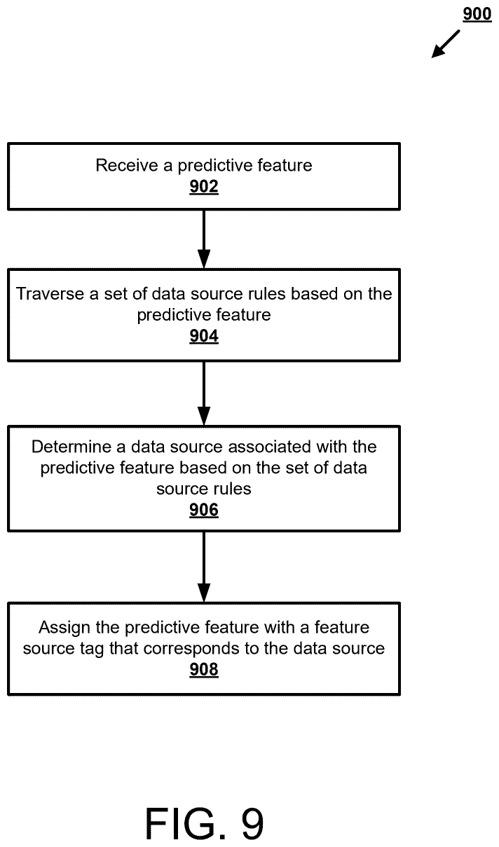

FIG. 9 depicts a flowchart diagram of an example feature source tagging process 900 in accordance with some embodiments of the present disclosure. The flowchart diagram depicts a feature source tagging process that assigns a feature source tag to a predictive feature based on a data source associated the predictive feature such that the predictive feature may be accurately attributed to a data source. The process 900 may be implemented by one or more computing devices, entities, and/or systems described herein. For example, via the various steps/operations of the process 900, the computing system 101 may determine a data source associated with a predictive feature based on a set of data set rules. By doing so, the process 900 improves computer functionality by improving the accuracy of source contributions that are provided to a computing entity or control system for performing downstream prediction-based tasks, decision and control operations, and/or allocation of computational resources in various decision and control contexts, such as robotic devices, autonomous vehicles, process control system, building automation system, and/or signaling systems.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 comprises, at operation 902, receiving a predictive feature. For example, the computing system 101 may receive a predictive feature.

In some embodiments, the process 900 comprises, at operation 904, traversing a set of data source rules based on the predictive feature. For example, the computing system 101 may traverse a set of data source rules based on the predictive feature.

In some embodiments, the process 900 comprises, at operation 906, determining a data source associated with the predictive feature based on the set of data source rules. For example, the computing system 101 may determine a data source associated with the predictive feature based on the set of data source rules.

In some embodiments, the process 900 comprises, at operation 908, assigning the predictive feature with a feature source tag that corresponds to the data source. For example, the computing system 101 may assign the predictive feature with a feature source tag that corresponds to the data source.

Some techniques of the present disclosure enable the generation of action outputs that may be performed to initiate one or more real world actions to achieve real-world effects. The techniques of the present disclosure may be used, applied, and/or otherwise leveraged to control operation of another computing entity, device, system, process (e.g., software), and/or any combination thereof, which may include load balancing of servers, allocating computing resources, and/or prioritizing tasks for execution by the servers. In some examples, the model outputs and/or source contributions of the present disclosure may trigger action outputs (e.g., through control instructions) to direct computer performance actions and/or the like. For example, the action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like. As another example, the action outputs may control data retrieval (e.g., of text, images, audio, and/or charts), processing (e.g., extraction, analysis), and/or generation of an output (e.g., signal, a secondary model output)

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by one or more processors, a model output from a machine learned model, wherein (i) the model output comprises a primary prediction that is generated by the machine learned model based on a model input comprising a set of predictive features, the set of predictive features comprising one or more predictive features, and (ii) a predictive feature of the set of predictive features corresponds to a feature source tag; generating, by the one or more processors and using an explanatory model, a set of feature contribution values for the set of predictive features with respect to the model output, the set of feature contribution values comprising one or more feature contribution values; generating, by the one or more processors, a source contribution for the feature source tag based on the set of feature contribution values, the source contribution indicating a contribution of a data source to the primary prediction; and initiating, by the one or more processors, performance of a prediction-based task based on the source contribution and the primary prediction.

Example 2. The computer-implemented example of claim 1, wherein the prediction-based task comprises: receiving a dataset that is associated with the primary prediction and a set of feature source tags comprising one or more feature source tags that comprise the feature source tag, the set of feature source tags comprising one or more source tags; and determining, based on the source contribution, a data subset of the dataset, wherein the data subset is associated with the feature source tag.

Example 3. The computer-implemented method of example 2, wherein the data subset comprises a subset of images from the dataset and the prediction-based task comprises: filtering the subset of images from the dataset based on the feature source tag; and inputting the subset of images to an image-based machine learned model to extract targeted data for the model output.

Example 4. The computer-implemented method of example 1, wherein the feature source tag corresponds to a subset of predictive features of the set of predictive features and the source contribution is determined by aggregating a subset of the set of feature contribution values that correspond to the subset of predictive features.

Example 5. The computer-implemented method of example 4, wherein: the source contribution comprises a first source contribution that corresponds to a first feature source tag of a set of feature source tags, the set of feature source tags comprising one or more feature source tags, the subset of predictive features comprises a first subset of predictive features that corresponds to the first feature source tag, the set of predictive features comprises a second subset of predictive features corresponding to a second feature source tag of the set of feature source tags, and the computer-implemented method further comprises: generating a second source contribution for the second feature source tag by aggregating another subset of the set of feature contribution values that correspond to the second subset of predictive features; and determining a secondary prediction for the primary prediction based on the first source contribution and the second source contribution.

Example 6. The computer-implemented method of example 4, wherein the machine learned model is a time-agnostic model and the model input comprises a plurality of feature occurrences of a data source predictive feature within the subset of predictive features and aggregating the subset of the set of feature contribution values comprises: generating an overall feature contribution value for the data source predictive feature by scaling a data source feature contribution value of the subset of the set of feature contribution values, wherein the data source feature contribution value corresponds to the data source predictive feature based on the plurality of feature occurrences of the data source predictive feature; and generating the source contribution based on the overall feature contribution value.

Example 7. The computer-implemented method of example 4, wherein the machine learned model is a time-based model and the set of feature contribution values comprises a particular feature contribution value for each feature occurrence of the predictive feature within the model input.

Example 8. The computer-implemented method of example 1, wherein a feature contribution value of the set of feature contribution values comprises a Shapley Additive exPlanations (SHAP) value.

Example 9. The computer-implemented method of example 1, wherein the primary prediction comprises a binary classification.

Example 10. The computer-implemented method of example 1, wherein the set of predictive features comprises a plurality of temporally aggregated feature occurrences that is received from a set of data sources, the set of data sources corresponds to a set of feature source tags, wherein the set of feature source tags comprises one or more feature source tags, and the computer-implemented method further comprises: receiving the model input; and generating, based on the set of data sources, a tagged model input by encapsulating, with the feature source tag, an occurrence of the predictive feature within the model input based on a data source of the set of data sources that originates the occurrence of the predictive feature, wherein (i) the plurality of temporally aggregated feature occurrences describes one or more actions that are associated with (a) one or more data sources of the set of data sources and (b) one or more time windows and (ii) the one or more actions are directed at a target entity associated with the primary prediction.

Example 11. A system comprising one or more processors and at least one memory storing processor-executable instructions that, when executed by any of the one or more processors, causes the one or more processors to perform operations comprising: receiving a model output from a machine learned model, wherein (i) the model output comprises a primary prediction that is generated by the machine learned model based on a model input comprising a set of predictive features, the set of predictive features comprising one or more predictive features, and (ii) a predictive feature of the set of predictive features corresponds to a feature source tag; generating, using an explanatory model, a set of feature contribution values for the set of predictive features with respect to the model output, the set of feature contribution values comprising one or more feature contribution values; generating a source contribution for the feature source tag based on the set of feature contribution values; and initiating a performance of a prediction-based task based on the source contribution and the primary prediction.

Example 12. The system of example 11, wherein the prediction-based task comprises: receiving a dataset that is associated with the primary prediction and a set of feature source tags, the set of feature source tags comprising one or more feature source tags; and determining, based on the source contribution, a data subset of the dataset, wherein the data subset is associated with the feature source tag.

Example 13. The system of example 12, wherein the data subset comprises a subset of images from the dataset and the prediction-based task comprises: filtering the subset of images from the dataset based on the feature source tag; and inputting the subset of images to an image-based machine learned model to extract targeted data for the model output.

Example 14. The system of example 11, wherein the feature source tag corresponds to a subset of predictive features of the set of predictive features and the source contribution is determined by aggregating a subset of the set of feature contribution values that correspond to the subset of predictive features.

Example 15. The system of example 11, wherein the feature source tag corresponds to a subset of predictive features of the set of predictive features and the source contribution is determined by aggregating a subset of the set of feature contribution values that correspond to the subset of predictive features.

Example 16. The system of example 15, wherein: the source contribution comprises a first source contribution that corresponds to a first feature source tag of a set of feature source tags, the set of feature source tags comprising one or more feature source tags, the subset of predictive features comprises a first subset of predictive features that corresponds to the first feature source tag, the set of predictive features comprises a second subset of predictive features corresponding to a second feature source tag of the set of feature source tags, and the operations further comprise: generating a second source contribution for the second feature source tag by aggregating another subset of the set of feature contribution values that correspond to the second subset of predictive features; and determining a secondary prediction for the primary prediction based on the first source contribution and the second source contribution.

Example 17. The system of example 15, wherein the machine learned model is a time-agnostic model and the model input comprises a plurality of feature occurrences of a data source predictive feature within the subset of predictive features and aggregating the subset of the set of feature contribution values comprises: generating an overall feature contribution value for the data source predictive feature by scaling a data source feature contribution value of the subset of the set of feature contribution values, wherein the data source feature contribution value corresponds to the data source predictive feature based on the plurality of feature occurrences of the data source predictive feature; and generating the source contribution based on the overall feature contribution value.

Example 18. The system of example 15, wherein the machine learned model is a time-based model and the set of feature contribution values comprises a particular feature contribution value for each feature occurrence of the predictive feature within the model input.

Example 19. The system of example 11, wherein the set of predictive features comprises a plurality of temporally aggregated feature occurrences that is received from a set of data sources, the set of data sources corresponds to a set of feature source tags, wherein the set of feature source tags comprises one or more feature source tags, and the operations further comprise: receiving the model input; and generating, based on the set of data sources, a tagged model input by encapsulating, with the feature source tag, an occurrence of the predictive feature within the model input based on a data source of the set of data sources that originates the occurrence of the predictive feature, wherein (i) the plurality of temporally aggregated feature occurrences describes one or more actions that are associated with (a) one or more data sources of the set of data sources and (b) one or more time windows and (ii) the one or more actions are directed at a target entity associated with the primary prediction.

Example 20. One or more non-transitory computer-readable storage media including instructions that, when executed by one or more processors, cause the one or more processors to perform operations comprising: receiving a model output from a machine learned model, wherein (i) the model output comprises a primary prediction that is generated by the machine learned model based on a model input comprising a set of predictive features, the set of predictive features comprising one or more predictive features, and (ii) a predictive feature of the set of predictive features corresponds to a feature source tag; generating, using an explanatory model, a set of feature contribution values for the set of predictive features with respect to the model output, the set of feature contribution values comprising one or more feature contribution values; generating a source contribution for the feature source tag based on the set of feature contribution values; and initiating a performance of a prediction-based task based on the source contribution and the primary prediction.

Example 21. The computer-implemented method of example 1, wherein the method further comprises training the machine learned model and/or the explanatory model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The system of example 11, wherein the operations further comprise training the machine learned model and/or the explanatory model.

Example 25. The system of example 24, wherein the one or more processors are comprised in a first computing entity; and the machine learned model and/or the explanatory model are trained by one or more other processors comprised in a second computing entity.

Example 26. The one or more non-transitory computer-readable storage media of example 20, wherein the operations further comprise training the machine learned model and/or the explanatory model.

Example 27. The one or more non-transitory computer-readable storage media of example 26, wherein the one or more processors are comprised in a first computing entity; and machine learned model and/or the explanatory model are trained by one or more other processors comprised in a second computing entity.

What is claimed is:

1. A computer-implemented method comprising:
receiving, by one or more processors, a model output from a machine learned model, wherein (i) the model output comprises a primary prediction that is generated by the machine learned model based on a model input comprising a set of predictive features, the set of predictive features comprising one or more predictive features, and (ii) a predictive feature of the set of predictive features corresponds to a feature source tag;
generating, by the one or more processors and using an explanatory model, a set of feature contribution values for the set of predictive features with respect to the model output, the set of feature contribution values comprising one or more feature contribution values;
generating, by the one or more processors, a source contribution for the feature source tag based on the set of feature contribution values, the source contribution indicating a contribution of a data source to the primary prediction; and
initiating, by the one or more processors, performance of a prediction-based task based on the source contribution and the primary prediction.

2. The computer-implemented method of claim 1, wherein the prediction-based task comprises:
receiving a dataset that is associated with the primary prediction and a set of feature source tags comprising one or more feature source tags that comprise the feature source tag, the set of feature source tags comprising one or more source tags; and
determining, based on the source contribution, a data subset of the dataset, wherein the data subset is associated with the feature source tag.

3. The computer-implemented method of claim 2, wherein the data subset comprises a subset of images from the dataset and the prediction-based task comprises:
filtering the subset of images from the dataset based on the feature source tag; and
inputting the subset of images to an image-based machine learned model to extract targeted data for the model output.

4. The computer-implemented method of claim 1, wherein the feature source tag corresponds to a subset of predictive features of the set of predictive features and the source contribution is determined by aggregating a subset of the set of feature contribution values that correspond to the subset of predictive features.

5. The computer-implemented method of claim 4, wherein:
the source contribution comprises a first source contribution that corresponds to a first feature source tag of a set of feature source tags, the set of feature source tags comprising one or more feature source tags,
the subset of predictive features comprises a first subset of predictive features that corresponds to the first feature source tag,
the set of predictive features comprises a second subset of predictive features corresponding to a second feature source tag of the set of feature source tags, and
the computer-implemented method further comprises:
generating a second source contribution for the second feature source tag by aggregating another subset of the set of feature contribution values that correspond to the second subset of predictive features; and
determining a secondary prediction for the primary prediction based on the first source contribution and the second source contribution.

6. The computer-implemented method of claim 4, wherein the machine learned model is a time-agnostic model and the model input comprises a plurality of feature occurrences of a data source predictive feature within the subset of predictive features and aggregating the subset of the set of feature contribution values comprises:
generating an overall feature contribution value for the data source predictive feature by scaling a data source feature contribution value of the subset of the set of feature contribution values, wherein the data source feature contribution value corresponds to the data source predictive feature based on the plurality of feature occurrences of the data source predictive feature; and
generating the source contribution based on the overall feature contribution value.

7. The computer-implemented method of claim 4, wherein the machine learned model is a time-based model and the set of feature contribution values comprises a particular feature contribution value for each feature occurrence of the predictive feature within the model input.

8. The computer-implemented method of claim 1, wherein a feature contribution value of the set of feature contribution values comprises a Shapley Additive exPlanations (SHAP) value.

9. The computer-implemented method of claim 1, wherein the primary prediction comprises a binary classification.

10. The computer-implemented method of claim 1, wherein the set of predictive features comprises a plurality of temporally aggregated feature occurrences that is received from a set of data sources, the set of data sources corresponds to a set of feature source tags, wherein the set of feature source tags comprises one or more feature source tags, and the computer-implemented method further comprises:
receiving the model input; and
generating, based on the set of data sources, a tagged model input by encapsulating, with the feature source tag, an occurrence of the predictive feature within the model input based on a data source of the set of data sources that originates the occurrence of the predictive feature, wherein (i) the plurality of temporally aggregated feature occurrences describes one or more actions that are associated with (a) one or more data sources of the set of data sources and (b) one or more time windows and (ii) the one or more actions are directed at a target entity associated with the primary prediction.

11. A system comprising
one or more processors and
at least one memory storing processor-executable instructions that, when executed by any of the one or more processors, causes the one or more processors to perform operations comprising:
receiving a model output from a machine learned model, wherein (i) the model output comprises a primary prediction that is generated by the machine learned model based on a model input comprising a set of predictive features, the set of predictive features comprising one or more predictive features, and (ii) a predictive feature of the set of predictive features corresponds to a feature source tag;
generating, using an explanatory model, a set of feature contribution values for the set of predictive features with respect to the model output, the set of feature contribution values comprising one or more feature contribution values;
generating a source contribution for the feature source tag based on the set of feature contribution values; and
initiating a performance of a prediction-based task based on the source contribution and the primary prediction.

12. The system of claim 11, wherein the prediction-based task comprises:
receiving a dataset that is associated with the primary prediction and a set of feature source tags, the set of feature source tags comprising one or more feature source tags; and
determining, based on the source contribution, a data subset of the dataset, wherein the data subset is associated with the feature source tag.

13. The system of claim 12, wherein the data subset comprises a subset of images from the dataset and the prediction-based task comprises:
filtering the subset of images from the dataset based on the feature source tag; and
inputting the subset of images to an image-based machine learned model to extract targeted data for the model output.

14. The system of claim 11, wherein the feature source tag corresponds to a subset of predictive features of the set of predictive features and the source contribution is determined by aggregating a subset of the set of feature contribution values that correspond to the subset of predictive features.

15. The system of claim 11, wherein the feature source tag corresponds to a subset of predictive features of the set of predictive features and the source contribution is determined by aggregating a subset of the set of feature contribution values that correspond to the subset of predictive features.

16. The system of claim 15, wherein:
the source contribution comprises a first source contribution that corresponds to a first feature source tag of a set of feature source tags, the set of feature source tags comprising one or more feature source tags,
the subset of predictive features comprises a first subset of predictive features that corresponds to the first feature source tag,
the set of predictive features comprises a second subset of predictive features corresponding to a second feature source tag of the set of feature source tags, and
the operations further comprise:
generating a second source contribution for the second feature source tag by aggregating another subset of the set of feature contribution values that correspond to the second subset of predictive features; and
determining a secondary prediction for the primary prediction based on the first source contribution and the second source contribution.

17. The system of claim 15, wherein the machine learned model is a time-agnostic model and the model input comprises a plurality of feature occurrences of a data source predictive feature within the subset of predictive features and aggregating the subset of the set of feature contribution values comprises:
generating an overall feature contribution value for the data source predictive feature by scaling a data source feature contribution value of the subset of the set of feature contribution values, wherein the data source feature contribution value corresponds to the data source predictive feature based on the plurality of feature occurrences of the data source predictive feature; and
generating the source contribution based on the overall feature contribution value.

18. The system of claim 15, wherein the machine learned model is a time-based model and the set of feature contribution values comprises a particular feature contribution value for each feature occurrence of the predictive feature within the model input.

19. The system of claim 11, wherein the set of predictive features comprises a plurality of temporally aggregated feature occurrences that is received from a set of data sources, the set of data sources corresponds to a set of feature source tags, wherein the set of feature source tags comprises one or more feature source tags, and the operations further comprise:
receiving the model input; and
generating, based on the set of data sources, a tagged model input by encapsulating, with the feature source tag, an occurrence of the predictive feature within the model input based on a data source of the set of data sources that originates the occurrence of the predictive feature, wherein (i) the plurality of temporally aggregated feature occurrences describes one or more actions that are associated with (a) one or more data sources of the set of data sources and (b) one or more time windows and (ii) the one or more actions are directed at a target entity associated with the primary prediction.

20. One or more non-transitory computer-readable storage media including instructions that, when executed by one or more processors, cause the one or more processors to perform operations comprising:
receiving a model output from a machine learned model, wherein (i) the model output comprises a primary prediction that is generated by the machine learned model based on a model input comprising a set of predictive features, the set of predictive features comprising one or more predictive features, and (ii) a predictive feature of the set of predictive features corresponds to a feature source tag;
generating, using an explanatory model, a set of feature contribution values for the set of predictive features with respect to the model output, the set of feature contribution values comprising one or more feature contribution values;
generating a source contribution for the feature source tag based on the set of feature contribution values; and
initiating a performance of a prediction-based task based on the source contribution and the primary prediction.
